(19) United States
(12) Patent Application Publication
(10) Pub. No.: US 2003/0118406 A1
(43) Pub. Date: Jun. 26, 2003

(54) Parallel fish channel

(76) Inventor: Robert E. Davis, Royal City, WA (US)

Correspondence Address: ROBERT E. DAVIS, P.O. Box 695, ROYAL CITY, WA, 99357, US

(21) Appl. No.: 10/324,205

(22) Filed: Dec. 19, 2002

Related U.S. Application Data
(60) Provisional application No. 60/342,039, filed on Dec. 26, 2001.

(51) Int. Cl. E02B 8/08; E02B 5/04; A01K 61/00

(52) U.S. Cl. 405/81; 405/84; 119/219

(57) ABSTRACT

Currently migratory fisheries are impeded in their upstream and downstream movements by one or more dams across rivers. A method and structure is described that overcomes the shortcomings of currently employed methods such as fish ladders, water spilling and barging. A channel of sufficient dimensions to simulate a natural stream bed is employed to parallel the entire length of river and reservoirs and provide passage for the fish. This is accomplished without the breaching and destruction of the dams bypassed.

### CROSS REFERENCE TO RELATED APPLICATIONS

This case comes from Provisional Patent No. 60/342,039

### STATEMENT REGARDING FEDERALLY SPONSORED RESEARCH OR DEVELOPMENT

Not Applicable

### REFERENCE TO SEQUENCE LISTING, A TABLE, ET AL

Not Applicable

### BACKGROUND OF THE INVENTION

This case comes from Provisional Patent No. 60/342,039. The invention applied for was sent by me, the first named inventor, to the Department of Energy Bonneville Power Administration on Feb. 27, 2000 as a comment on the Federal Caucus Conservation of Columbia Basin Fish “All-H Paper” and subsequently acknowledged by letter on Jul. 10, 2001 in the published summary of collected comments. It was proposed as an alternative solution to breaching the four dams on the lower Snake River of Washington State to preserve the migratory fish runs without sacrificing the Navigation, Irrigation, Recreation, Hydropower and Fish/Wildlife benefits of the dams.

### BRIEF SUMMARY OF THE INVENTION

The invention consists of construction of a channel parallel to the river but separated by a wall, to bypass entire sections of a river and its dams that would allow upstream and downstream fish migration on a grade approximating that of a natural stream. The channel would use the existing shoreline as one side and a wall made of concrete or other durable material as the other side. The benefits of the Parallel Fish Channel would be to retain the existing dams for Navigation, Irrigation, Recreation, Hydropower and Fish/Wildlife, while providing for migrating fisheries:

a) Easy upstream migration for spawning

b) Natural downstream migration for smolts

c) Considerable additional spawning grounds

d) Swifter flow of water in channel to reduce heat absorption (remain colder) and eliminate the need to pass through the warm water of reservoirs

e) Eliminate need for smolts to go over dams and suffer Nitrogen poisoning or go through the turbines and be destroyed

Additionally it would save the costs of removing the dams while retaining the economic benefits of existing dams. It would avoid resorting to trucks to transport grain/lumber with their greater fuel consumption, safety hazards, road erosion, and air pollution. If made of concrete, it would last as long as the dams themselves and the water flow in the Parallel Fish Channel could be directly controlled to facilitate optimum flow for fish with the remainder of the river flow going through the dams. Currently, the fish get only the remaining water left over from the dams. Also avoided would be an estimated 10 years of destruction of spawning habitat by silt flow if dams are removed.

### BRIEF DESCRIPTION OF THE SEVERAL VIEWS OF THE DRAWING

FIG. 1—Overall View

This is the overall view of the specific situation where this invention could be applied to save the four dams on the lower Snake River in the State of Washington.

FIG. 2—Conceptual Layout

This is a not to scale illustration of how the parallel channel would follow the natural grade of the land as it bypasses the alternate deep and shallow water backed up behind the dams.

FIG. 3—Cross Section of Dam End of the Reservoir

This shows a cross sectional view of the parallel channel at the deep end of a reservoir and how the water in the parallel channel would remain at a nominally constant depth.

FIG. 4—Cross Section of Upper End of Reservoir

This shows how the water in the parallel channel could remain the same nominally constant depth as at the deep end of the reservoir.

FIG. 5—Flow Control

This is one possible configuration for controlling the flow of water through the bypass channel to maintain the nominally constant flow as the water level in the river/reservoir fluctuates.

### DETAILED DESCRIPTION OF THE INVENTION

This invention is different from previous methods of bypassing dams for the benefit of migratory fisheries in that a grade level channel is proposed to bypass multiple dams that allows a much easier channel for fish to locate and negotiate than current day fish ladders. Because it would be at the grade level of the surrounding land the fall would be much less steep with a corresponding reduction in velocity of the water passing through. This would appear to migratory fishes as a natural stream and in fact could have a bottom consisting of gravel and boulders to provide significant additional spawning habitat. As a natural appearing stream, it would also appeal to downstream migrating fingerlings as a preferable path as opposed to the slow moving reservoirs behind each dam where the water is higher in temperature and reduced in oxygen.

The channel would use an existing shoreline of the existing reservoir/river system as one side and a wall made of concrete or other durable material as the other side. It would be of sufficient width (in the order of 30 feet) and sufficient depth (six to ten feet) to be conducive to migratory fish passage and spawning, with a concrete bottom covered with natural rocks, boulders and gravel to simulate a natural stream bottom. The channel would retain these same nominal dimensions throughout the entire length of the bypass.

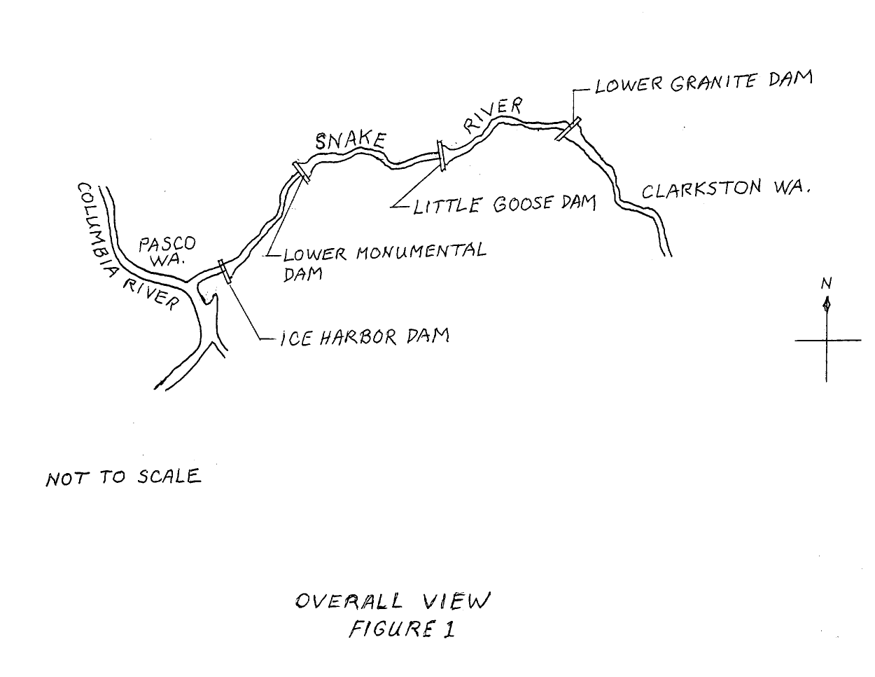

FIG. 1 is an example of where this invention could be applied to bypass the four dams on the lower Snake River in the State of Washington. This is roughly a 150 mile stretch of river and reservoirs that would be bypassed at roughly the grade of the free flowing river before the dams were built. Alternatively, a bypass channel could be constructed around one, two, or three of the dams and their associated reservoirs.

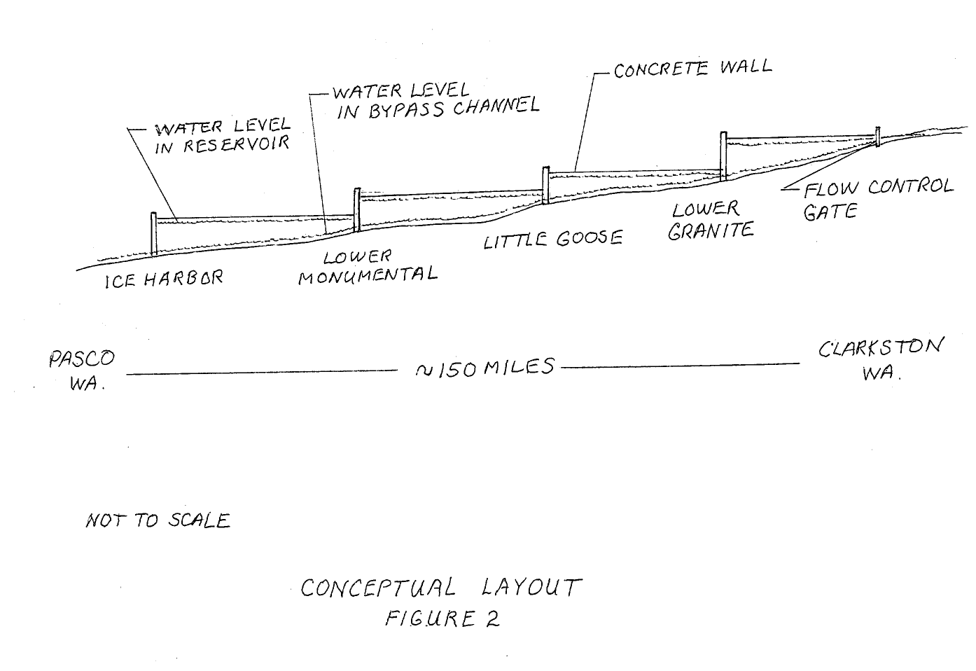

FIG. 2 shows the same example of the four dams on the lower Snake River in the State of Washington and how the bypass channel would follow the grade of the surrounding shoreline while maintaining the nominally constant width and depth at all points along its path.

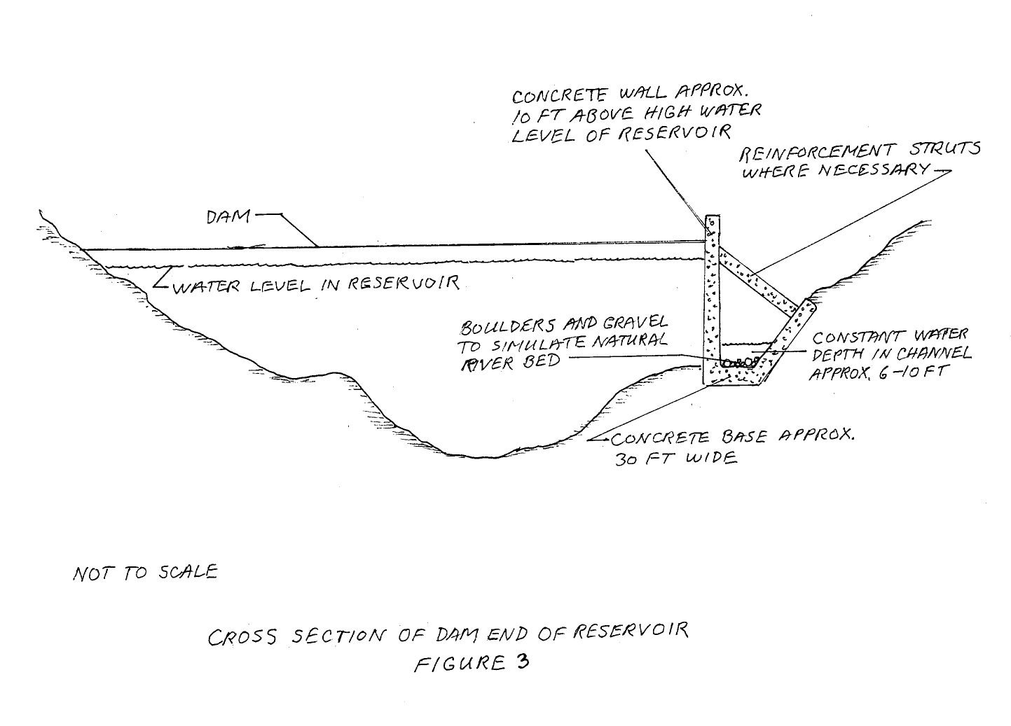

FIG. 3 illustrates the cross section of the river at the dam and how the bypass channel would be considerably below the depth of the water in the reservoir while retaining its normal width and depth. Because of the height of the separating wall at this point reinforcement struts would need to be employed to support the wall separating the bypass channel from the reservoir.

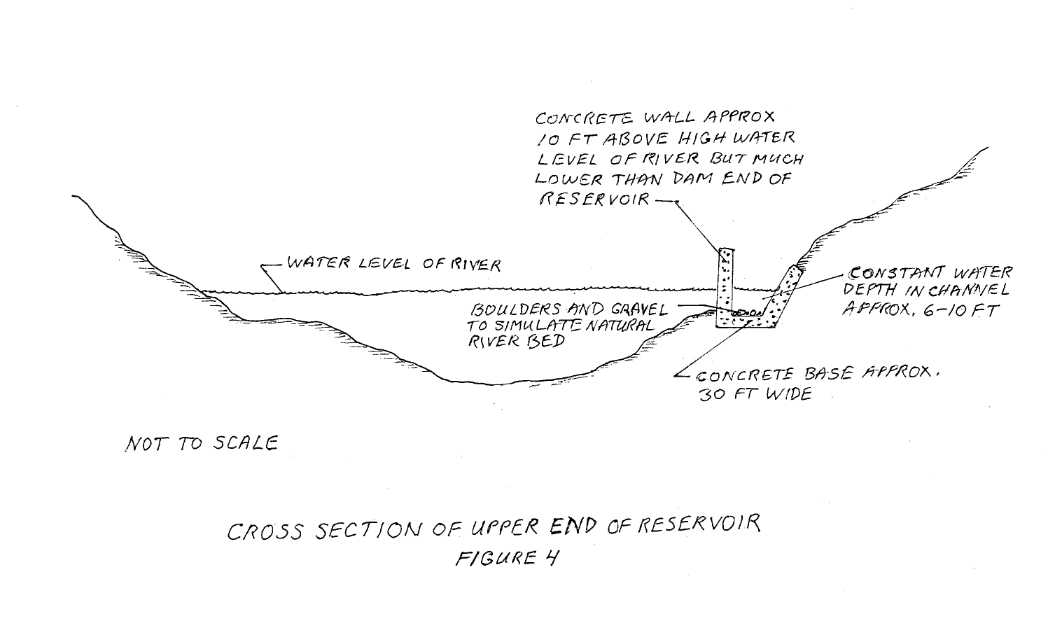

FIG. 4 illustrates the cross section of the river at the upper end of the reservoir and how the water level in the reservoir is closer to the level in the bypass channel. At this end of the reservoir, and along any free flowing sections of river between dams, the wall separating the bypass channel from the river/reservoir would be much lower and consequently would require less supports or reinforcement struts.

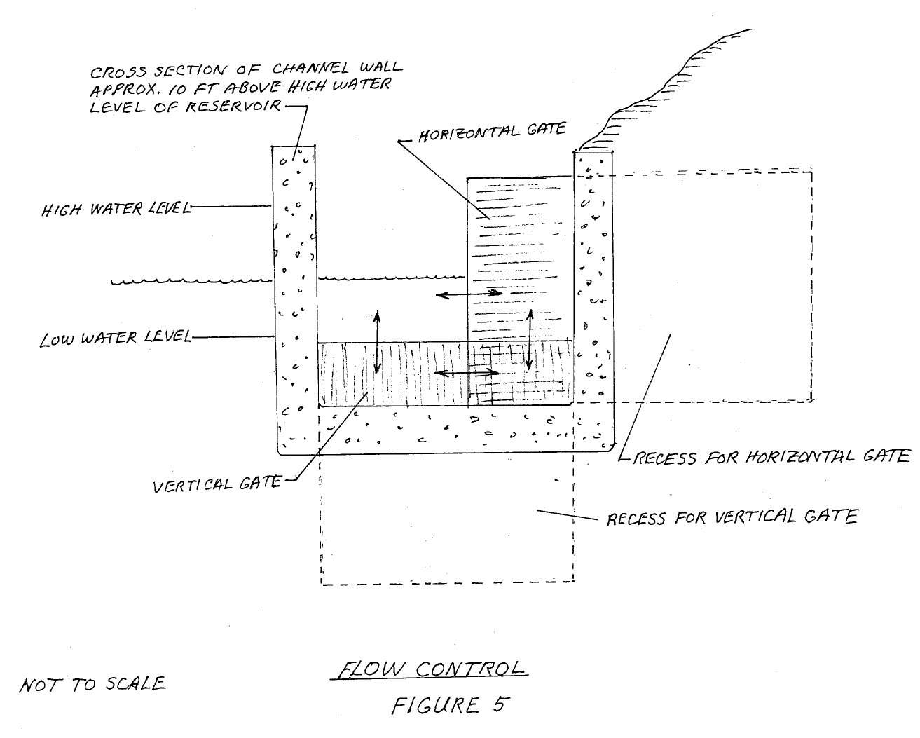

To control the flow of water through the bypass channel and to provide optimum conditions for the fish, a flow control gate should be installed near the inlet for the channel at the upper end of the upstream reservoir. This control must be able to regulate the water entering the channel from high water levels down to low water levels. FIG. 5 shows one possible means for doing this utilizing a combination of horizontal and vertical gates that could regulate the water flow without creating an impossible drop or excessive water velocity at the gate.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted, falling within the scope of the invention.

What is claimed as being new and desired to be protected by Letters Patent of the us is as follows:

1. A process and structure to allow migratory fish to bypass dams and reservoirs in a river, with a manmade channel parallel to the river, that would follow the original grade of the land as to when it was a free flowing river and would be so constructed so as to allow free passage both upstream and downstream for migratory fish along the entire stretch of dams and reservoirs to create additional spawning habitat along its length and overcomes the shortcomings of currently used fish ladders, barges, and water spillage without the breaching and destruction of the existing dams with their multiple benefits.
